(19) United States
(12) Patent Application Publication
(10) Pub. No.: US 2022/0390078 A1
(43) Pub. Date: Dec. 8, 2022

(54) ELECTRIC DEVICE AND ELECTRIC DEVICE SYSTEM

(71) Applicant: Koki Holdings Co., Ltd., Tokyo (JP)

(72) Inventors: Satoshi TACHI, Ibaraki (JP); Shinichi SAKUMA, Ibaraki (JP)

(73) Assignee: Koki Holdings Co., Ltd., Tokyo (JP)

(21) Appl. No.: 17/775,581

(22) PCT Filed: Oct. 30, 2020
(86) PCT No.: PCT/JP2020/040881

§ 371 Date: May 9, 2022

(30) Foreign Application Priority Data
Nov. 28, 2019 (JP) 2019-214995

(51) Int. Cl. F21L 4/02; H05B 45/14

(52) U.S. Cl. CPC F21L 4/027; H05B 45/14; F21Y 2115/10

(57) ABSTRACT

Provided are an electric device and an electric device system. The electric device is provided with a battery pack attachment part, main LEDs, and a sub-LED. The main LEDs are lit by electric power from a battery pack. The sub-LED illuminates the battery pack attached to the battery pack attachment part or the battery pack attachment part. The sub-LED is lit when the voltage or capacity of the battery pack is below a predetermined value. The sub-LED is lit by electric power from a power supply part different from the battery pack.

### TECHNICAL FIELD

The present invention relates to an electric device such as a lighting device and an electric device system.

### BACKGROUND ART

The following Patent Literature 1 relates to a cordless lamp. This cordless lamp includes a fluorescent tube that is lit by the electric power from a battery pack that is detachably attached. The fluorescent tube is covered with a transparent cylindrical fluorescent tube cover. A fluorescent seal is stuck to an upper end part of the fluorescent tube cover over the entire circumference. When the fluorescent tube is lit, the fluorescent seal receives light from a back surface side through the fluorescent tube cover. The fluorescent seal emits light for a while even after the fluorescent tube is lit off. Therefore, even if the cordless lamp is lit off after use and placed in a dark place, the place where the cordless lamp is placed can be immediately known by the light emission of the fluorescent seal.

### CITATION LIST

### Patent Literature

[Patent Literature 1] Japanese Unexamined Patent Publication No. 2010-205736

### SUMMARY OF INVENTION

### Technical Problem

The cordless lamp of Patent Literature 1 does not take in to account the visibility when the battery pack is replaced in a dark place.

An object of the present invention is to provide an electric device and an electric device system capable of improving visibility when replacing a battery pack in a dark place.

### Solution to Problem

One aspect of the invention is an electric device. The electric device includes a battery pack attachment part to which a battery pack is detachably attached; an illumination part that illuminates the battery pack attached to the battery pack attachment part or the battery pack attachment part; a power supply part different from the battery park and serving as a power source for the illumination part; and a control part that controls the illumination part.

Another aspect of the present invention is an electric device.

The electric device includes a battery pack attachment part to which a battery pack is detachably attached; an illumination part that illuminates the battery pack attached to the battery pack attachment part or the battery pack attachment part regardless of whether or not the battery pack is attached; a control part that controls the illumination part; and a power supply part separately provided from the battery pack and serving as a power source for the illumination part, at least in a state where the battery pack is not attached.

The illumination part may illuminate the battery pack attachment part when the battery pack is not attached to the battery pack attachment part.

The illumination part is able to be lit when a voltage or a capacity of the battery pack attached to the battery pack attachment part is below a predetermined value.

The illumination part may be directed toward the battery pack attachment part.

The battery pack attachment part includes a pair of rail parts for guiding an attachment of the battery pack; a device-side terminal part connected to a terminal part of the battery pack is provided at the battery pack attachment part; and the illumination part may illuminate at least the pair of rail parts or the device-side terminal part.

The power supply part includes any one of a primary battery, a capacitor, and a secondary battery; and when the power supply part is the capacitor or the secondary battery, it may be charged by an electric power from the battery pack attached to the battery pack attachment part.

The control part may be operable with an electric power from the power supply part.

A cover that covers the battery pack attachment part is included, and the illumination part may include at least one of a first illumination part arranged outside of the cover or a second illumination part arranged inside the cover.

The illumination part may be lit off when the cover is in a closed state and lit when the cover is in an open state.

The cover may include a window part, and part of a light of the second illumination part may go outside of the cover through the window part.

A main light part different from the illumination part and lit by an electric power from the battery pack attached to the battery pack attachment part may be provided.

The control part may light off the illumination part after a predetermined time from lighting-on.

When there are a plurality of lighting-off conditions for lighting off the illumination part and the plurality of lighting-off conditions are satisfied while the illumination part is lit, the control part may light off the illumination part according to the lighting-on condition satisfied later, from among the plurality of lighting-off conditions.

Another aspect of the present invention is an electric device system including the battery pack; and an electric device.

Note that any combination of the above components or conversion of expression of the present invention between methods are also effective as aspects of the present invention.

### Effects of Invention

According to the present invention, an electric device and an electric device system capable of improving visibility when replacing a battery pack in a dark place can be provided.

### BRIEF DESCRIPTION OF DRAWINGS

FIG. 1 is a front perspective view of an electric device 1 according to an Embodiment 1 of the present invention.

FIG. 2 is a side sectional view of the electric device 1.

FIG. 3 is a rear perspective view of the electric device 1.

FIG. 4 is a schematic block diagram of the electric device 1.

FIG. 5 is a time chart showing a first example of the operation of the electric device 1.

FIG. 6 is a time chart showing a second example of the operation of the electric device 1.

FIG. 7 is a time chart showing a third example of the operation of the electric device 1.

FIG. 8 is a time chart showing a fourth example of the operation of the electric device 1.

FIG. 9 is a time chart showing a fifth example of the operation of the electric device 1.

FIG. 10 is a time chart showing a sixth example of the operation of the electric device 1.

FIG. 11 is a front perspective view of an electric device 1A according to an Embodiment 2 of the present invention.

FIG. 12 is a side sectional view of the electric device 1A.

FIG. 13 is a rear perspective view of the electric device 1A in a state where a cover 17 is opened.

FIG. 14 is a rear perspective view of the electric device 1A in a state where the cover 17 is closed.

FIG. 15 is a perspective view of an electric device 1B according to an Embodiment 3 of the present invention.

FIG. 16 is a side sectional view of an electric device 1C according to an Embodiment 4 of the present invention.

FIG. 17 is a rear perspective view of an electric device 1D according to an Embodiment 5 of the present invention.

### DESCRIPTION OF EMBODIMENTS

In the following, the same or equivalent components, members, etc. shown in the drawings are designated by the same reference numerals, and redundant descriptions will be omitted where appropriate. The embodiments are example, not limitations, of the invention. Not all features and combinations thereof described in the embodiments are essential to the invention.

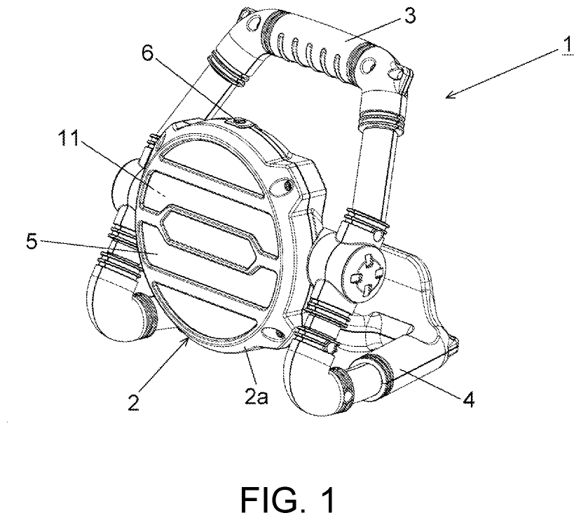

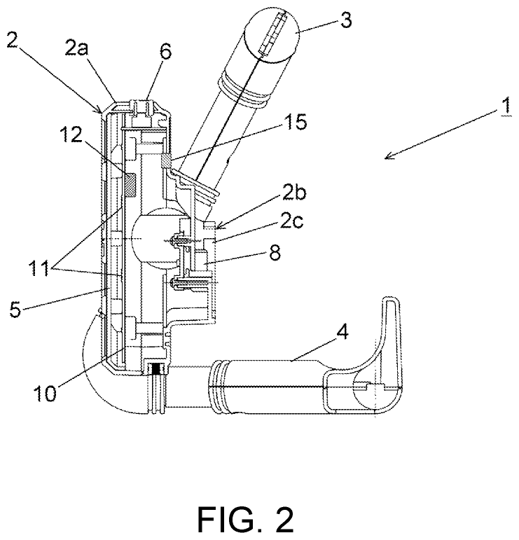

(Embodiment 1) An Embodiment 1 of the present invention will be described with reference to FIGS. 1 to 10. The present embodiment relates to an electric device 1 and an electric device system. The electric device 1 is a lighting device referred to as a cordless work light. The electric device 1 includes a housing 2, a top handle 3, and a bottom handle 4. The top handle 3 and the bottom handle 4 are integrated with each other or connected to each other. The bottom handle 4 also functions as a stand part when placed on the floor or the like. The housing 2 is rotatably connected to and supported by the top handle 3 and the bottom handle 4.

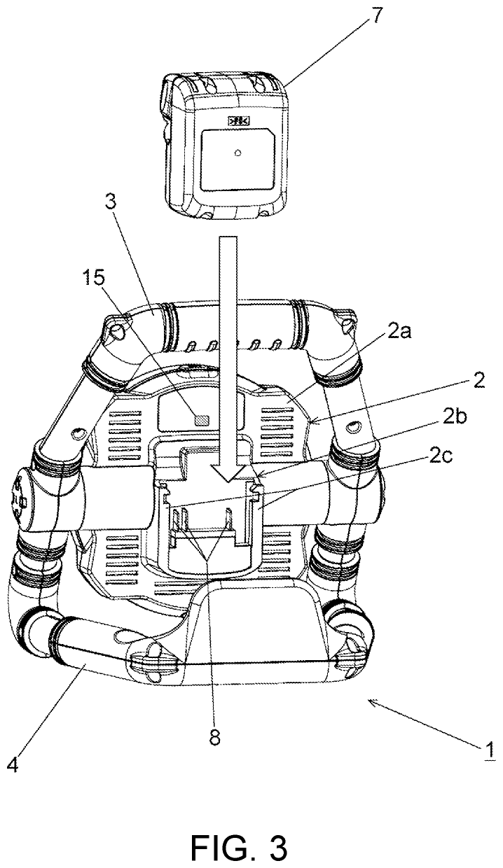

The housing 2 is, for example, a resin molded body. The housing 2 includes an accommodating part 2a and a battery pack attachment part 2b. A light transmitting front cover 5 is provided so as to cover an open front end of the accommodating part 2a. A switch 6 is provided on an upper surface of the accommodating part 2a. The battery pack attachment part 2b is provided on a back surface of the accommodating part 2a. The battery pack attachment part 2b detachably attaches a battery pack 7. As shown in FIG. 3, the battery pack 7 is attached by sliding from above with respect to the battery pack attachment part 2b. The combination of the electric device 1 and the battery pack 7 is the electric device system. The battery pack attachment part 2b includes a pair of rail parts 2c for guiding the attachment of the battery pack 7. A device-side terminal part 8 is provided on the battery pack attachment part 2b. The device-side terminal part 8 is electrically connected in contact with the terminal part of the battery pack 7.

A substrate 10 is accommodated inside the accommodating part 2a. A plurality of main LEDs 11 constituting a main light part are provided on a front surface of the substrate 10. The main LEDs 11 are lit by the electric power from the battery pack 7. Each time an operator presses the switch 6, the lighting-on state of the main LEDs 11 switches. The lighting-on state includes three types, for example: lighting-on in a strong mode, lighting-on in a weak mode, and lighting-off. A power supply part 12 is provided on a back surface of the substrate 10. The power supply part 12 is a primary battery, a capacitor, or a secondary battery. When the power supply part 12 is a capacitor, the power supply part 12 is charged by the electric power from the battery pack 7 attached to the battery pack attachment part 2b.

A sub-LED (emergency light) 15 serving as an illumination part is provided at a position on the back surface of the accommodating part 2a above the battery pack attachment part 2b. The sub-LED 15 is lit by the electric power from the power supply part 12. The sub-LED 15 illuminates the battery pack 7 attached to the battery pack attachment part 2b or the battery pack attachment part 2b. The sub-LED 15 illuminates the battery pack 7 when the battery pack 7 is attached to the battery pack attachment part 2b. The sub-LED 15 illuminates the battery pack attachment part 2b when the battery pack 7 is not attached (no attachment) on the battery pack attachment part 2b. At this time, the sub-LED 15 illuminates at least the rail parts 2c. The sub-LED 15 is directed toward the battery pack attachment part 2b. The switching of the lighting-on state of the sub-LED 15 will be described later. The sub-LED 15 directly or indirectly illuminates the battery pack 7 and the battery pack attachment part 2b such that the operator can visually recognize the battery pack 7 and the battery pack attachment part 2b. Here, “directly” means that at least a part of the optical axis of the sub-LED 15 faces the battery pack 7 or the battery pack attachment part 2b, and “indirectly” means that the optical axis of the sub-LED 15 does not face the battery pack 7 or the battery pack attachment part 2b, but the battery pack 7 or the battery pack attachment part 2b is made visible by reflection or the like.

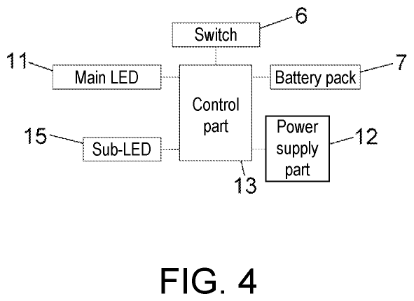

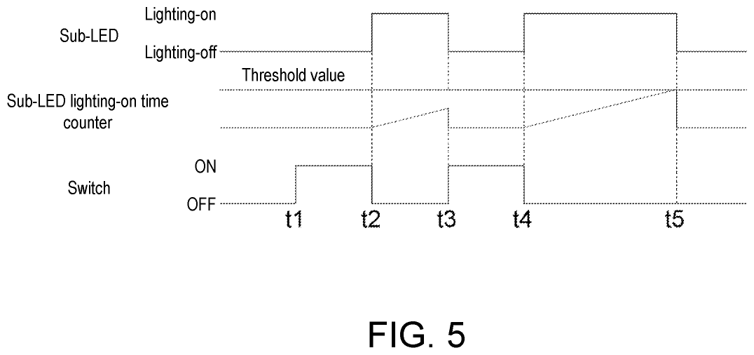

FIG. 4 is a schematic block diagram of the electric device 1. A control part 13 is, for example, a microcontroller mounted on the substrate 10. The control part 13 is operated by the electric power from the battery pack 7. When its own voltage or capacity drops, the battery pack 7 transmits a discharge prohibition signal (LD signal) to the control part 13. Upon receiving the discharge prohibition signal, the control part 13 controls such that the battery pack 7 is not discharged. When the discharge prohibition signal is received or the battery pack 7 is removed, the control part 13 can be operated by the electric power from the power supply part 12. The control part 13 detects the operation of the switch 6, the attachment and detachment of the battery pack 7, and the voltage or capacity of the battery pack 7. The control part 13 controls the lighting-on of the main LEDs 11 according to the operation of the switch 6. The control part 13 controls the lighting-on of the sub-LED 15 in response to the operation of the switch 6, the attachment and detachment of the battery pack 7, and the discharge prohibition signal from the battery pack 7. Hereinafter, the lighting-on control of the sub-LED 15 by the control part 13 will be described with reference to FIGS. 5 to 10.

FIG. 5 is a time chart showing the lighting-on control of the sub-LED 15 according to the on/off of the switch 6. The switch 6 is turned on at time t1, and the switch 6 is turned off at the subsequent time t2. Then, the control part 13 lights the sub-LED 15 and starts measuring the lighting-on time. A counter built in the control part 13 is used for time measurement. When the count value reaches a threshold value, it means that a predetermined time has elapsed from the lighting-on of the sub-LED 15. The switch 6 is turned on at time t3 before the count value reaches the threshold value. Then, the control part 13 lights off the sub-LED 15 and resets the counter for measuring the lighting-on time (initializes the count value to 0). When the switch 6 is turned off at the subsequent time t4, the control part 13 lights the sub-LED 15 and starts measuring the lighting-on time. When the count value reaches the threshold value at time t5, the control part 13 lights off the sub-LED 15 and resets the counter.

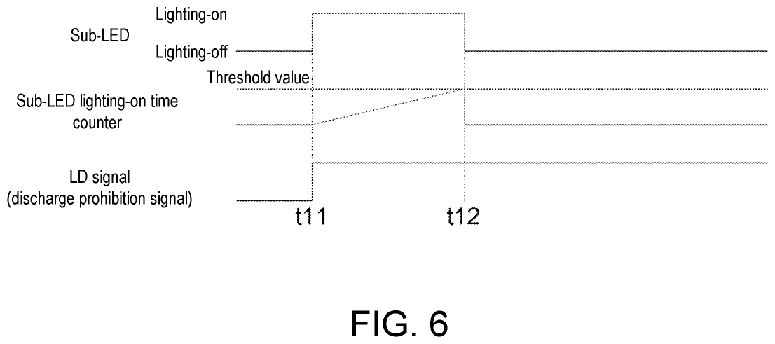

FIG. 6 is a time chart showing lighting-on control of the sub-LED 15 according to the discharge prohibition signal from the battery pack 7. The control part 13 receives a discharge prohibition signal from the battery pack 7 at time t11 (detects that the discharge prohibition signal has changed from a low level to a high level). Then, the control part 13 lights the sub-LED 15 and starts measuring the lighting-on time. When the count value reaches the threshold value at time t12, the control part 13 lights off the sub-LED 15 and resets the counter.

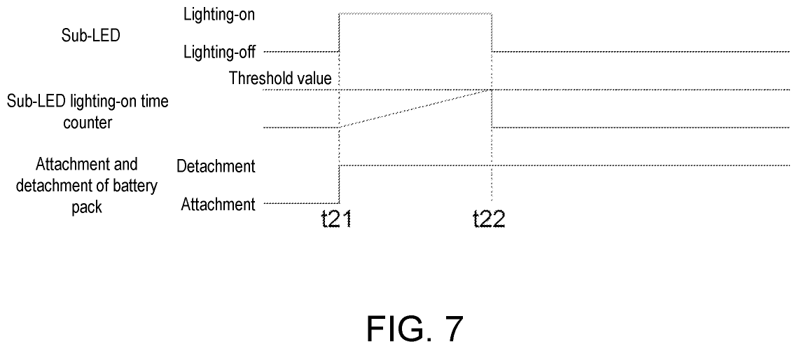

FIG. 7 is a time chart showing lighting-on control of the sub-LED 15 according to attachment and detachment of the battery pack 7. When the battery pack 7 is removed at time t21, the control part 13 lights the sub-LED 15 and starts measuring the lighting-on time. When the count value reaches the threshold value at time t22, the control part 13 lights off the sub-LED 15 and resets the counter.

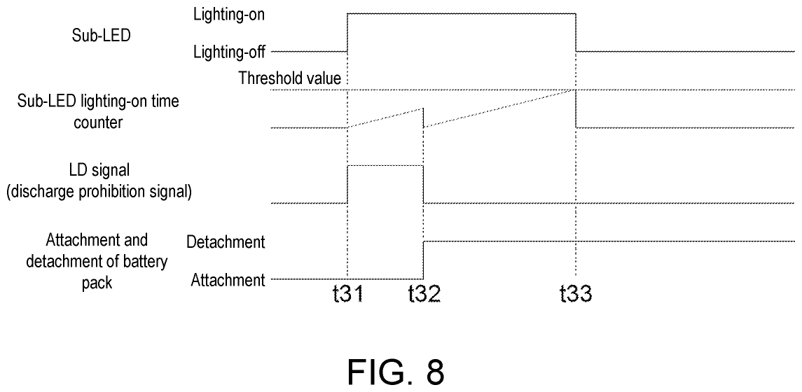

FIG. 8 is a time chart showing lighting-on control of the sub-LED 15 when the battery pack 7 is removed after receiving the discharge prohibition signal from the battery pack 7. Upon receiving the discharge prohibition signal from the battery pack 7 at time t31, the control part 13 lights the sub-LED 15 and starts measuring the lighting-on time. When the battery pack 7 is removed at time t32 before the count value reaches the threshold value, the control part 13 resets the counter while maintaining lighting of the sub-LED 15, and starts measuring the lighting-on time again. When the count value reaches the threshold value at time t33, the control part 13 lights off the sub-LED 15 and resets the counter.

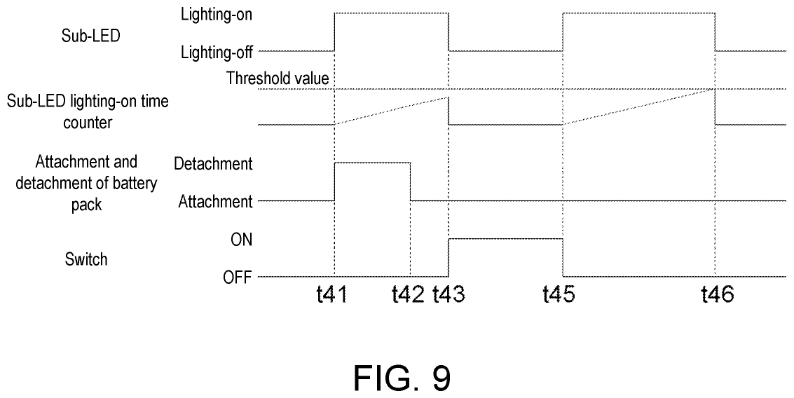

FIG. 9 is a time chart showing lighting-on control of the sub-LED 15 when the switch 6 is operated after the battery pack 7 is replaced. When the battery pack 7 is removed at time t41, the control part 13 lights the sub-LED 15 and starts measuring the lighting-on time. The battery pack 7 is attached at time t42 before the count value reaches the threshold value, but the control part 13 maintains lighting of the sub-LED 15. That is, the attachment of the battery pack 7 does not trigger the lighting off of the sub-LED 15. When the switch 6 is turned on at time t43 before the count value reaches the threshold value, the control part 13 lights off the sub-LED 15 and resets the counter for measuring the lighting-on time. When the switch 6 is turned off at time t45, the control part 13 lights the sub-LED 15 and starts measuring the lighting-on time. When the count value reaches the threshold value at time t46, the control part 13 lights off the sub-LED 15 and resets the counter.

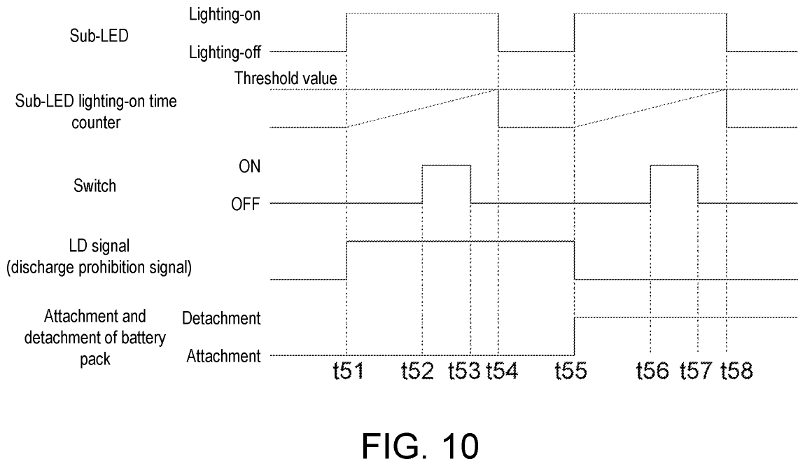

FIG. 10 is a time chart showing lighting-on control of the sub-LED 15 when the switch 6 is operated when the discharge prohibition signal is received and when the switch 6 is operated when the battery pack 7 is removed. Upon receiving the discharge prohibition signal from the battery pack 7 at time t51, the control part 13 lights the sub-LED 15 and starts measuring the lighting-on time. The switch 6 is turned on at time t52 before the count value reaches the threshold value, but the control part 13 maintains lighting of the sub-LED 15 and continues the time measurement without resetting the counter. That is, when the discharge prohibition signal is received, turning on the switch 6 does not trigger the lighting off of the sub-LED 15 and the counter reset. The switch 6 is turned off at time t53 before the count value reaches the threshold value, but the control part 13 continues the time measurement without resetting the counter. That is, when the discharge prohibition signal is received, turning off the switch 6 does not trigger a counter reset (trigger re-start of the time measurement). When the count value reaches the threshold value at time t54, the control part 13 lights off the sub-LED 15 and resets the counter.

When the battery pack 7 is removed at time t55, the control part 13 lights the sub-LED 15 and starts measuring the lighting-on time. The switch 6 is turned on at time t56 before the count value reaches the threshold value, but the control part 13 maintains lighting of the sub-LED 15 and continues the time measurement without resetting the counter. That is, when the battery pack 7 is removed, turning on the switch 6 does not trigger the lighting off of the sub-LED 15 and the counter reset. The switch 6 is turned off at time t57 before the count value reaches the threshold value, but the control part 13 continues the time measurement without resetting the counter. That is, when the battery pack 7 is removed, turning off the switch 6 does not trigger a counter reset. When the count value reaches the threshold value at time t58, the control part 13 lights off the sub-LED 15 and resets the counter. In order to cut off the supply of electric power from the battery pack 7 to the main LEDs 11, by setting a threshold value for the voltage or capacity of the battery pack 7 and setting this threshold value to a value that is satisfied before the threshold value for transmitting the discharge prohibition signal of the battery pack 7, even if the power supply part 12 is not provided separately, the sub-LED 11 can be lit until the battery pack 7 is prohibited from discharging by using the electric power from the battery pack 7.

According to the present embodiment, the following effects can be obtained.

(1) When the voltage or capacity of the battery pack 7 drops to a predetermined value or less, a discharge prohibition signal is transmitted from the battery pack 7, and the sub-LED 15 is lit by the electric power from the power supply part 12 different from the battery pack 7. The sub-LED 15 illuminates the battery pack 7. That is, when the voltage or capacity of the battery pack 7 drops and the main LEDs 11 cannot be lit, the sub-LED 15 automatically lights on to illuminate the battery pack 7. Therefore, it is possible to improve the visibility when the battery pack 7 is removed in a dark place, that is, when replacing the battery pack 7.

(2) When the battery pack 7 is removed, the sub-LED 15 is lit by the electric power from the power supply part 12 different from the battery pack 7. The sub-LED 15 illuminates the battery pack attachment part 2b, particularly the rail parts 2c. Therefore, it is possible to improve visibility when attaching a new battery pack 7 in a dark place, that is, when replacing the battery pack 7.

(3) The sub-LED 15 is automatically lit off when it is lit for a predetermined time. Therefore, the consumption of the power supply part 12 can be suppressed.

(4) If the sub-LED 15 is already lit on when the battery pack 7 is removed, the lighting-on time of the sub-LED 15 is extended by the removal of the battery pack 7. Therefore, it is possible to prevent the sub-LED 15 from lighting off while the new battery pack 7 is being attached.

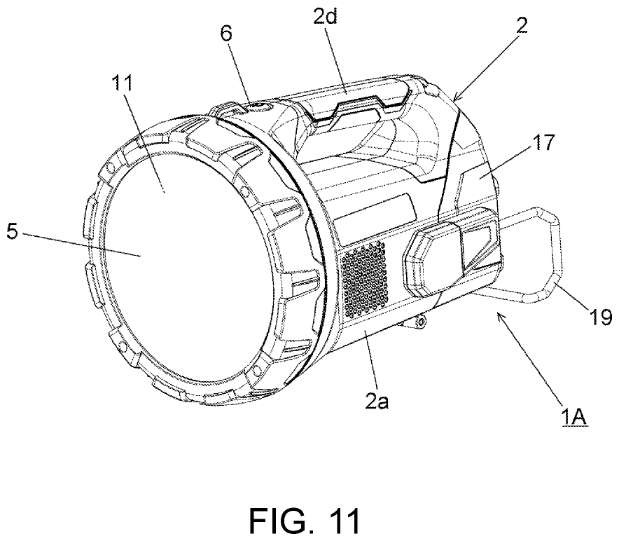

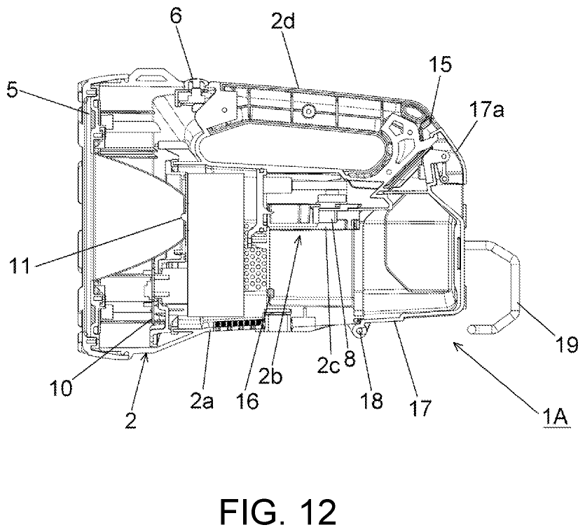

(Embodiment 2) An Embodiment 2 of the present invention will be described with reference to FIGS. 11 to 14. The present embodiment relates to an electric device 1A. The electric device 1A is a lighting device, specifically a handheld cordless light. The following will focus on differences from the Embodiment 1. The housing 2 includes a handle part 2d. The handle part 2d is provided so as to pass between an upper rear end part and an upper front end part of the accommodating part 2a. The switch 6 is provided on an upper surface of the handle part 2d. A stand part 19 is provided so as to pass between left and right side surfaces of the accommodating part 2a. The stand part 19 is rotatable with respect to the housing 2.

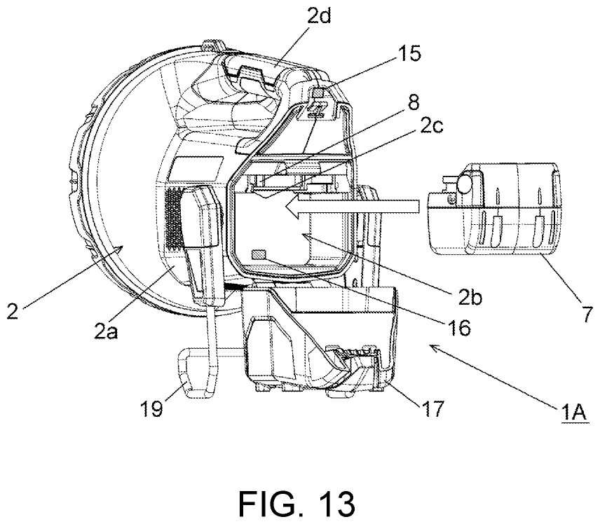

The battery pack attachment part 2b is provided at a rear part of the accommodating part 2a. As shown in FIG. 13, the battery pack 7 is slid from the rear and attached to the battery pack attachment part 2b. A cover 17 is openably/closably provided at a rear end part of the accommodating part 2a. The cover 17 covers the battery pack attachment part 2b and the battery pack 7 attached thereto in a closed state. The cover 17 is rotatably connected to the housing 2 via a shaft part 18 constituting a hinge mechanism. The cover 17 includes a latch mechanism 17a. The latch mechanism 17a locks the cover 17 in a closed state with respect to the housing 2.

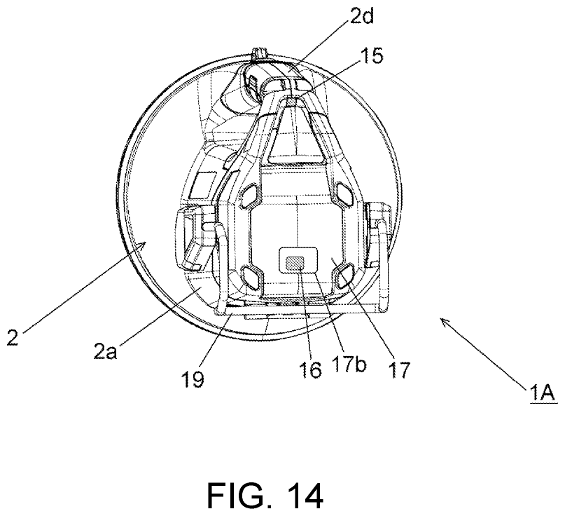

The sub-LED 15 serving as a first illumination part is provided at a portion at a rear end part of the handle part 2d, one that is located outside of the cover 17. A sub-LED 16 serving as a second illumination part is provided at a surface facing the rear of the housing 2, a surface that is located inside of the cover 17. As shown in FIG. 14, the cover 17 includes a window part 17b. The window part 17b may be a through hole or may be blocked with a light transmitting member. When the cover 17 is in a closed state, part of the light of the sub-LED 16 goes outside of the cover 17 through the window part 17b. Like the sub-LED 15, the sub-LED 16 is also lit by the electric power from the power supply part 12 shown in FIG. 4. The sub-LED 16 has the same function as the sub-LED 15.

The control part 13 shown in FIG. 4 also controls the lighting-on of the sub-LED 16. The lighting-on control of the sub-LEDs 15 and 16 by the control part 13 is the same as the lighting-on control of the sub-LED 15 in the Embodiment 1. In addition thereto, in the present embodiment, the control part 13 may control the lighting-on of the sub-LEDs 15 and 16 according to the opening and closing of the cover 17. In this case, the control part 13 also detects the opening and closing of the cover 17. For the opening and closing the cover 17, a signal from a switch (not shown) that is switched on and off by opening and closing the cover 17 can be used. The control part 13 lights off the sub-LEDs 15 and 16 when the cover 17 is in a closed state. The control part 13 lights the sub-LEDs 15 and 16 when the cover 17 is in an open state.

The present embodiment can also have the same effect as that of the Embodiment 1. According to the present embodiment, even when the battery pack attachment part 2b is covered with the cover 17, since the window part 17b is provided on the cover 17, the light of the sub-LED 16 inside the cover 17 can go outside of the cover 17. Therefore, it is possible to improve the visibility when opening the cover 17 to replace the battery pack 7. In the present embodiment, either one of the sub-LEDs 15 and 16 may be omitted. When the sub-LED 16 is omitted, the window part 17b of the cover 17 may be omitted.

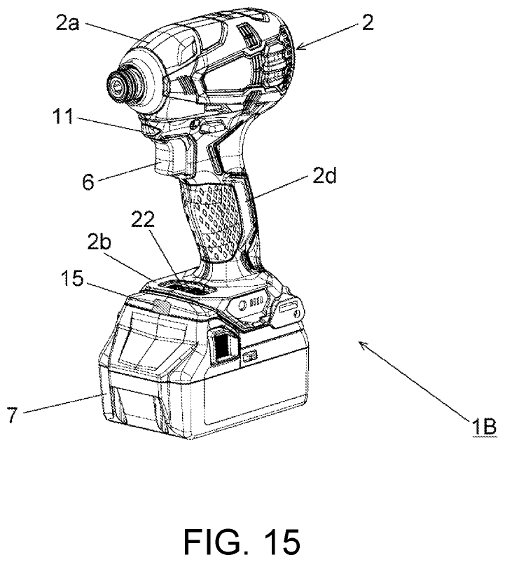

(Embodiment 3) FIG. 15 is a perspective view of an electric device 1B according to an Embodiment 3 of the present invention. The electric device 1B is a power tool, more specifically an impact driver. The following will focus on differences from the Embodiment 1. The housing 2 has a shape in which the handle part 2d extends downward from the center of the accommodating part 2a. The battery pack attachment part 2b is provided at a lower end part of the handle part 2d. The battery pack 7 is attached to the battery pack attachment part 2b by sliding from the front. The switch 6 is provided at an upper end part of the handle part 2d. The main LEDs 11 are provided at a position above the switch 6 on a front surface of the housing 2. An operation panel 22 is provided on an upper surface of a front part of the battery pack attachment part 2b. The operation panel 22 is provided with a switch for the operator for switching the lighting-on state of the mains LED 11. The sub-LED 15 is provided at the center of the front end part of the battery pack attachment part 2b. The lighting-on control of the sub-LED 15 is the same as that of the Embodiment 1. The present embodiment can also have the same effect as that of the Embodiment 1.

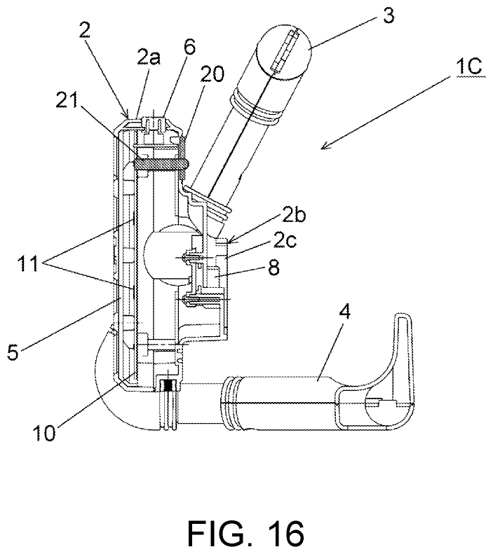

(Embodiment 4) FIG. 16 is a side sectional view of an electric device 1C according to an Embodiment 4 of the present invention. The electric device 1C is a lighting device, more specifically a cordless work light. The electric device 1C is different from the electric device 1 of the Embodiment 1 in that the power supply part 12 is eliminated, the illumination part is replaced from the sub-LED 15 to a light accumulating body 20, and a light guide path (light guide member) 21 is added, and the two are the same in other respects. The light guide path 21 penetrates the substrate 10 in the front-rear direction, and further penetrates the back surface of the accommodating part 2a in the front-rear direction. The lights emitted by the main LEDs 11 are emitted behind the accommodating part 2a through the light guide path 21. The light accumulating 20 is provided near the emission part of the light guide path 21 on the back surface of the accommodating part 2a. This structure allows the light emitted from the light guide path 21 to effectively illuminate the light accumulating body 20. The accumulating body 20 accumulates light while the main LEDs 11 are lit and emit light for a while even when the main LEDs 11 are lit off. According to the present embodiment, it is possible to improve the visibility when the battery pack 7 is being replaced in a dark place without providing a power source different from the battery pack.

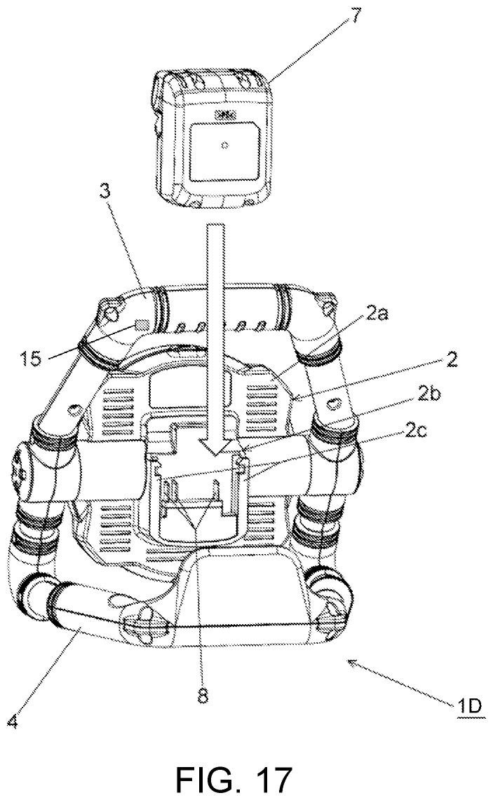

(Embodiment 5) FIG. 17 is a modified example of the electric device 1 according to an Embodiment 1 of the present invention. The sub-LED 15 is provided on the top handle 3 and is arranged so as to illuminate the battery pack 7 or the battery pack attachment part by the electric power from the power supply part 12. The power supply part 12 is provided on the back surface of the base 10 as in the Embodiment 1, and is charged by the electric power from the battery pack 7 attached to the battery pack attachment part 2b. In this manner, the sub-LED 15 may be provided at a position capable of illuminating the battery pack 7 or the battery pack attachment part 2b, and the sub-LED 15 may be provided on the top handle 3 or the bottom handle 4. Further, the power supply part 12 may be provided not only inside the sub-LED 15 and the housing 2, but also inside the top handle 3 and the bottom handle 4.

Although the present invention has been described above by taking the embodiments as examples, it shall be understood by those skilled in the art that various modifications can be made to each component and each processing process of the embodiment within the scope of the claims. For example, at least one of the main LEDs 11 or the sub-LEDs 15 and 16 may be replaced with a light source different from the LED (light emitting diode). A switch for manually lighting the sub-LEDs 15 and 16 may be provided. A cover having the same function as the cover 17 of the Embodiment 2 may be provided in the electric devices of the Embodiments 1, 3, and 4.

### REFERENCE SIGNS LIST

1, 1A-1D . . . Electric device 2 . . . Housing 2a . . . Accommodating part 2b . . . Battery pack attachment part 2c . . . Rail part 2d . . . Handle part 3 . . . Top handle 4 . . . Bottom handle 5 . . . Front cover 6 . . . Switch 7 . . . Battery pack 8 . . . Device-side terminal part 10 . . . Substrate 11 . . . Main LEDs (main light part) 12 . . . Power supply part 13 . . . Control part 15 . . . Sub-LED (illumination part) 16 . . . Sub-LED (illumination part) 17 . . . Cover 17a . . . Latch mechanism 17b . . . Window part 18 . . . Shaft part 19 . . . Stand part 20 . . . Light accumulating body (illumination part) 21 . . . Light guide path 22 . . . Operation panel

1. An electric device, comprising:
a battery pack attachment part to which a battery pack is detachably attached;
an illumination part that illuminates the battery pack attached to the battery pack attachment part or the battery pack attachment part;
a power supply part different from the battery pack and serving as a power source for the illumination part; and
a control part that controls the illumination part.

2. An electric device, comprising:
a battery pack attachment part to which a battery pack is detachably attached;
an illumination part that illuminates the battery pack attached to the battery pack attachment part or the battery pack attachment part regardless of whether or not the battery pack is attached;
a control part that controls the illumination part; and
a power supply part separately provided from the battery pack and serving as a power source for the illumination part, at least in a state where the battery pack is not attached.

3. The electric device according to claim 1, wherein the illumination part illuminates the battery pack attachment part when the battery pack is not attached to the battery pack attachment part.

4. The electric device according to claim 1, wherein the illumination part is able to be lit when a voltage or a capacity of the battery pack attached to the battery pack attachment part is below a predetermined value.

5. The electric device according to claim 1, wherein the illumination part is directed toward the battery pack attachment part.

6. The electric device according to claim 1, wherein the battery pack attachment part comprises a pair of rail parts for guiding an attachment of the battery pack;
a device-side terminal part connected to a terminal part of the battery pack is provided at the battery pack attachment part; and
the illumination part illuminates at least the pair of rail parts or the device-side terminal part.

7. The electric device according to claim 1, wherein the power supply part comprises any one of a primary battery, a capacitor, and a secondary battery; and
when the power supply part is the capacitor or the secondary battery, it is charged by an electric power from the battery pack attached to the battery pack attachment part.

8. The electric device according to claim 1, wherein the control part is operable with an electric power from the power supply part.

9. The electric device according to claim 1, comprising a cover that covers the battery pack attachment part, and
the illumination part comprises at least one of a first illumination part arranged outside of the cover or a second illumination part arranged inside of the cover.

10. The electric device according to claim 9, wherein the illumination part is lit off when the cover is in a closed state and lit when the cover is in an open state.

11. The electric device according to claim 9, wherein the cover comprises a window part, and part of a light of the second illumination part goes outside of the cover through the window part.

12. The electric device according to claim 1, comprising a main light part different from the illumination part and lit by an electric power from the battery pack attached to the battery pack attachment part.

13. The electric device according to claim 1, wherein the control part lights off the illumination part after a predetermined time from lighting-on.

14. The electric device according to claim 1, wherein when there are a plurality of lighting-off conditions for lighting off the illumination part and the plurality of lighting-off conditions are satisfied while the illumination part is lit, the control part lights off the illumination part according to a lighting-off condition satisfied later, from among the plurality of lighting-off conditions.

15. An electric device system, comprising:
the battery pack according to claim 1; and
an electric device.

16. The electric device according to claim 2, wherein the illumination part illuminates the battery pack attachment part when the battery pack is not attached to the battery pack attachment part.

17. The electric device according to claim 2, wherein the illumination part is able to be lit when a voltage or a capacity of the battery pack attached to the battery pack attachment part is below a predetermined value.

18. The electric device according to claim 3, wherein the illumination part is able to be lit when a voltage or a capacity of the battery pack attached to the battery pack attachment part is below a predetermined value.

19. An electric device system, comprising:
the battery pack according to claim 2; and
an electric device.
